(19) United States
(12) Patent Application Publication
(10) Pub. No.: US 2024/0019983 A1
(43) Pub. Date: Jan. 18, 2024

(54) CAPACITIVE HOVER SENSING MODULE AND METHOD

(71) Applicant: EMERGING DISPLAY TECHNOLOGIES CORP., Kaoshiung (TW)

(72) Inventor: Chih-Hung LU, Hualien County (TW)

(73) Assignee: EMERGING DISPLAY TECHNOLOGIES CORP., Kaohsiung (TW)

(21) Appl. No.: 17/882,773

(22) Filed: Aug. 8, 2022

(30) Foreign Application Priority Data
Jul. 13, 2022 (TW) 111126308

(51) Int. Cl. G06F 3/04817; G06F 3/041

(52) U.S. Cl. CPC G06F 3/04817; G06F 3/041662; G06F 3/04186; G06F 3/0412; G06F 2203/04108

(57) ABSTRACT

A capacitive hover sensing module includes: a capacitive touch panel for sensing a self-capacitive projective position of a conductor object on the capacitive touch panel; a touch driver chip drives the capacitive touch panel for measuring a sensing signal induced by the conductor object, and generates and outputs a sensing data accordingly; a processor receives the sensing data output and thereby generates the self-capacitive projective position of the conductor object on the capacitive touch panel when the conductor object hovers over the capacitive touch panel, the processor also generates a hover value related to a vertical distance between the conductor object and the capacitive touch panel, wherein the capacitive hover sensing module transmits the self-capacitive projective position and the hover value to a display device to display the self-capacitive projective position of the conductor object on the capacitive touch panel through a corresponding positioning feedback icon.

### CROSS REFERENCE TO RELATED APPLICATION(S)

This non-provisional application claims the benefit under 35 U.S.C. § 119(e) to patent application No. 111126308 filed in Taiwan on Jul. 13, 2022, which is hereby incorporated in its entirety by reference into the present application.

### BACKGROUND OF THE INVENTION

### 1. Field of the Invention

The present invention relates to a hover sensing module, especially to a capacitive hover sensing module and method.

### 2. Description of the Related Art

Under the global pandemic, demands have risen for software services and hardware equipment such as personal computers, tablets, and monitors. Since surfaces of objects are potentially subject to virus contamination, people tend to avoid touching the objects directly. Such scenario increases demands for non-contact touch products. FIG. 4 shows a capacitive hover sensing device 40 based on non-contact touch technology. A user's finger 41 is above the capacitive hover sensing device 40 and within a range of a predefined height dt to operate the capacitive hover sensing device 40. When the user's finger 41 has not entered the sensing range, which means the user's finger 41 is above the capacitive hover sensing device 40 and above the height dt, conventionally the user's finger 41 cannot operate the capacitive hover sensing device 40, because even though the user's finger 41 is already above the capacitive hover sensing device 40, the user's finger 41 is too high from the capacitive hover sensing device 40 (i.e. higher than the predefined height dt), and the capacitive hover sensing device 40 has difficulties in processing the sensing signal induced by the user's finger 41 due to its relatively small signal magnitude. However, even if the user's finger is not within the sensing range of the height dt, the capacitive hover sensing device 40 is still capable of sensing the relatively small sensing signal induced by the user's finger 41, and how to fully utilize the relatively small sensing signal induced by the user's finger 41 to further enhance the functionalities of the capacitive hover sensing device is in urgent demand.

### SUMMARY OF THE INVENTION

In order to fulfill the above demands, the present invention proposes a capacitive hover sensing module, comprising:

a capacitive touch panel for sensing a self-capacitive projective position of a conductor object on the capacitive touch panel, the conductor object located in a space facing the capacitive touch panel;

a touch driver chip, electrically connected with the capacitive touch panel and driving the capacitive touch panel, for measuring a sensing signal induced by the conductor object, and generating and outputting a sensing data accordingly;

a processor, electrically connected with the touch driver chip, for receiving the sensing data output by the touch driver chip;

according to the sensing data, in addition to generating the self-capacitive projective position of the conductor object on the capacitive touch panel when the conductor object is hovering over the capacitive touch panel, the processor also generating a hover value related to a vertical distance between the conductor object and the capacitive touch panel when the conductor object is hovering over the capacitive touch panel; wherein

the capacitive hover sensing module transmits the self-capacitive projective position and the hover value to a system end having a display device to display the self-capacitive projective position of the conductor object on the capacitive touch panel through a corresponding positioning feedback icon on the display device; wherein

a size of the positioning feedback icon is determined by the hover value of the conductor object.

Preferably, the capacitive hover sensing module measures a self-capacitive sensing value in the vertical direction of the surface of the capacitive touch panel;

when the self-capacitive sensing value is between a third threshold and a second threshold, the display device displays a third positioning feedback icon, and the size of the third positioning feedback icon is determined by a third hover value;

when the self-capacitive sensing value is between a second threshold and a first threshold, the display device displays a second positioning feedback icon, and the size of the second positioning feedback icon is determined by a second hover value;

when the self-capacitive sensing value is between the first threshold and a contact threshold, the display device displays a first positioning feedback icon, and the size of the first positioning feedback icon is determined by a first hover value; wherein

the third threshold is less than the second threshold, the second threshold is less than the first threshold, and the first threshold is less than the contact threshold; and

the third hover value is greater than the second hover value, and the second hover value is greater than the first hover value.

The present invention also proposes a capacitive hover sensing method, including the following steps:

measuring a self-capacitive sensing value induced by a conductive object hovering over a capacitive touch panel;

defining N threshold regions, connected by respective endpoints, and between a minimum threshold value and a maximum threshold value, where N is an integer greater than or equal to 2;

when the self-capacitive sensing value is between the minimum threshold and the maximum threshold, the self-capacitive sensing value is determined to be within a k^{th} threshold region among the N threshold regions, a hover value of the conductive object is set to a k^{th} hover value, where k is an integer greater than or equal to 1 and less than or equal to N; wherein

according to the self-capacitive sensing value, a self-capacitive projection position is calculated and output, and thereby a display device displays the self-capacitive projection position through a k^{th} positioning feedback icon, wherein the size of the k^{th} positioning feedback icon is determined by the k^{th} hover value of the conductive object.

As mentioned above, a capacitive hover sensing module of the present invention collaborates with a display device and a graphical user interface to generate a positioning feedback icon via the graphical user interface and display a positioning feedback icon on the display device, and use the positioning feedback icon to assist the user's vision. After the user sees the positioning feedback icon, in addition to allowing the user to confirm a projective position of his finger on a capacitive touch panel, the user can be further reminded about the height of his finger currently above the capacitive touch panel through the sizes of the positioning feedback icons, thereby enhancing functionalities of the capacitive hover sensing technology and providing a helpful user experience is provided. The present invention fully utilize signals sensed for the finger hovering over the capacitive hover sensing module of the present invention, and the purposes of the present invention to enhance the functionalities of capacitive hover sensing effect and provide a helpful user experience are thus achieved.

### BRIEF DESCRIPTION OF THE DRAWINGS

FIG. 1 is a schematic diagram of a capacitive hover sensing module of the present invention cooperating with a system end;

FIG. 2 is a schematic diagram of sensing spaces and their corresponding modes and hover values of the present invention;

FIGS. 3A-3C are schematic diagrams of the positioning feedback icons corresponding to each hover value of the present invention;

FIG. 4 is a flow chart of the capacitive hover sensing method of the present invention; and

FIG. 5 is a schematic diagram of an application of a conventional capacitive hover sensing device.

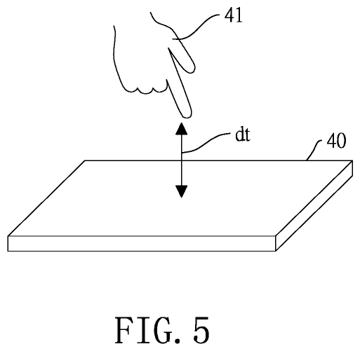

### DETAILED DESCRIPTION OF THE INVENTION

In the following, the technical solutions in the embodiments of the present invention will be clearly and fully described with reference to the drawings in the embodiments of the present invention. Obviously, the described embodiments are only a part of, not all of, the embodiments of the present invention. Based on the embodiments of the present invention, all other embodiments obtained by a person of ordinary skill in the art without creative efforts shall fall within the protection scope of the present invention.

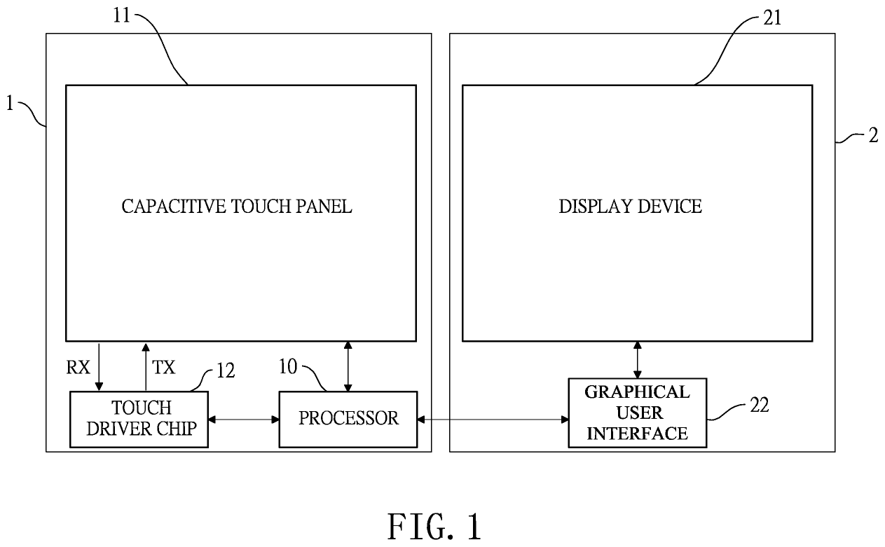

Please refer to FIG. 1. In addition to showing a capacitive hover sensing module 1 of the present invention, FIG. 1 also shows a system end 2 collaborating with the capacitive hover sensing module 1 of the present invention. The capacitive hover sensing module 1 of the present invention includes a capacitive touch panel 11, a touch driver chip 12 and a processor 10. The system end 2 includes a display device 21 and a graphical user interface 22.

The capacitive touch panel 11 includes a two-dimensional (2D) electrode array composed of a plurality of transverse electrodes and a plurality of longitudinal electrodes insulated from each other. The main function of the capacitive touch panel 11 is to sense a conductor object, such as a finger, in a space facing the capacitive touch panel 11, to determine a projective position of the conductor object on the 2D electrode array of the capacitive touch panel 11, as a 2D coordinate point (X, Y) or a region, wherein the “projective position” may be either a sensed position (i.e. a contact sensed position) induced by the conductor object directly contacting the capacitive touch panel 11, or a sensed position (i.e. a hover sensed position) induced by the conductor object hovering over the capacitive touch panel 11. The touch driver chip 12 has a driver circuit, which can output an analog driving signal TX to drive the 2D electrode array on the capacitive touch panel 11, and receive a sensing signal RX generated by a common response of the conductor object and the 2D electrode array in response to the analog signal TX, and thereby to generate and output a sensing data to the processor 10. The processor 10 can calculate according to the sensing data to obtain a projective position of the conductor object on the capacitive touch on panel 11, as a 2D coordinate point (X, Y) or an area. The processor 10 can be a controller chip such as a microcontroller unit (MCU), a microprocessor unit (MPU) or a central processor unit (CPU) having an embedded memory and/or an external memory.

The system end 2 refers to an application device utilizing the capacitive hover sensing module 1, such as a tablet computer, a mobile phone or a personal computer. In the system end 2, the display device 21 displays according to the instructions of the graphical user interface 22, and the graphical user interface 22 can receive a projected position of the conductor object sent by the capacitive hover sensing module 1, as a 2D coordinates point (X, Y) or an area, to generate an image corresponding to the projected position of the conductor object, and the projected position of the conductor object is displayed on the display device 21 through the corresponding image.

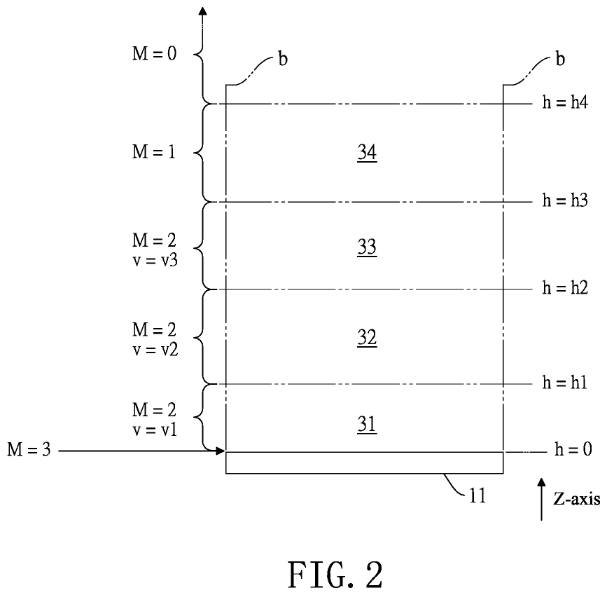

After receiving the sensing signal from the touch driver chip 12, the processor 10 determines a sensing mode M and a hover value v of the conductor object relative to the capacitive touch panel 11, wherein both the sensing mode M and the hover value v are related to distance ranges between the capacitive touch panel 11 and the conductor object. Please refer to FIG. 2, which shows a height variable h in Z-axis direction, where h=h0 represents a surface of the capacitive touch panel 11, h=h1 represents a horizontal plane corresponding to a first height h1 above the surface of the touch panel 11, h=h2 represents a horizontal plane corresponding to a second height h2 above the surface of the capacitive touch panel 11, h=h3 represents a horizontal plane corresponding to a third height h3 above the surface of the capacitive touch panel 11, and h=h4 represents a horizontal plane corresponding to a fourth height h4 above the surface of the capacitive touch panel 11, where 0<h1<h2<h3<h4, for example: h1=15 mm, h2=35 mm, h3=50 mm, h4=100 mm. FIG. 2 also shows a vertical perimeter surface b formed by the extension of the perimeter of the sensing area of the capacitive touch panel 11 along the z-axis direction.

The horizontal plane corresponding to the first height h1, the surface of the capacitive touch panel 11 and the vertical perimeter surface b together form a first sensing space 31; the horizontal plane corresponding to the second height h2, the horizontal plane corresponding to the first height h1 and the vertical perimeter surface b together form a second sensing space 32; the horizontal plane corresponding to the third height h3, the horizontal plane corresponding to the second height h2 and the vertical perimeter surface b together form a third sensing space 33; the horizontal plane corresponding to the fourth height h4, the horizontal plane corresponding to the third height h3 and the vertical perimeter surface b together form a fourth sensing space 34.

When the conductor object is in contact with the surface of the capacitive touch panel 11, the sensing mode M of the conductor object is set to 3, and the conductor object is in direct contact with the surface of the capacitive touch panel 11. When the conductor object is located in the first sensing space 31, the sensing mode M of the conductor object is set to 2 and the hover value v is set to a first hover value v1 (such as 5 mm), at this moment the conductor object is hovering over the surface of the capacitive touch panel 11; when a conductor object is located in the second sensing space 32, the sensing mode M of the conductor object is set to 2 and the hover value v is set to a second hover value v2 (such as 10 mm), at this moment the conductor object is also hovering over the surface of the capacitive touch panel 11; when a conductor object is located in the third sensing space 33, the sensing mode M of the conductor object is set to 2 and the hover value v is set to a third hover value v3 (such as 15 mm), at this moment the conductor object is also hovering over the surface of the capacitive touch panel 11; when a conductor object is located in the fourth sensing space 34, the sensing mode M of the conductor object is set to 1, at this moment the conductor object is in proximity to the surface of the capacitive touch panel 11; when a conductor object is located above the fourth sensing space 34, the sensing mode M of the conductor object is set to 0.

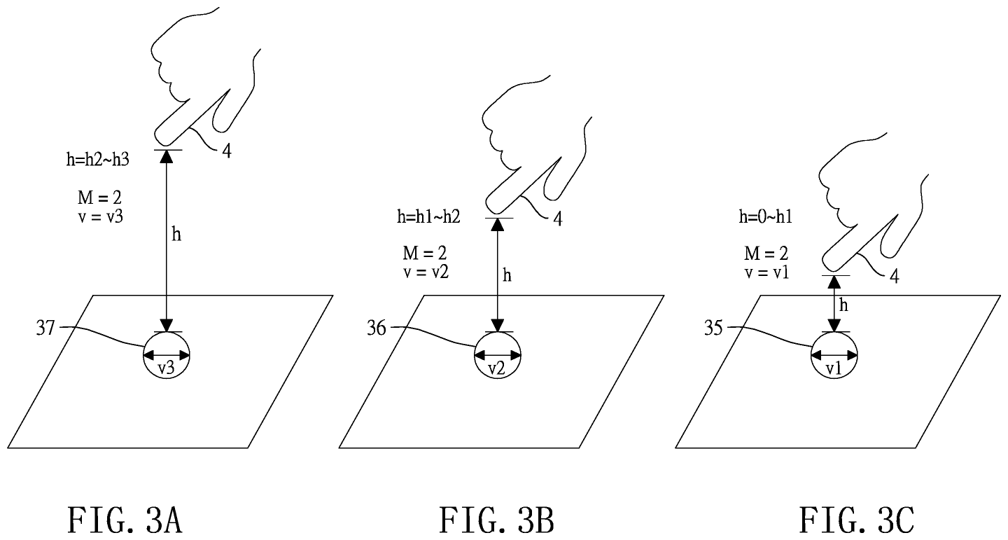

Please refer to FIG. 3A-3C. FIG. 3A shows that a finger 4 is located between the horizontal plane corresponding to the third height h3 and the horizontal plane corresponding to the second height h2 (i.e. the third sensing space 33), and the sensing mode sensing M of the finger 4 is set to 2 and its hover value v is the third hover value v3, at this moment the display device 21 displays a third positioning feedback icon 37 according to the instruction of the graphical user interface 22, and the third positioning feedback icon 37 is a circle whose diameter is the third hover value v3 (i.e., 15 mm). Similarly, FIG. 3B shows that a finger 4 is located between the horizontal plane corresponding to the second height h2 and the horizontal plane corresponding to the first height h1 (i.e., the second sensing space 32), and the sensing mode M of the finger 4 is set to 2 and its hover value v is the second hover value v2, at this moment the display device 21 displays a second positioning feedback icon 36 according to the instruction of the graphical user interface 22, and the second positioning feedback icon 36 is a circle whose diameter is the second hover value v2 (i.e., 10 mm). Similarly, FIG. 3C shows that a finger 4 is located between the horizontal plane corresponding to the first height h1 and the surface of the capacitive touch panel 11 (i.e. the first sensing space 31), and the sensing mode M of the finger 4 is set to 1 and its hover value v is the first hover value v1, at this moment the display device 21 displays a first positioning feedback icon 35 according to the instruction of the graphical user interface 22, and the first positioning feedback icon 35 is a circle whose diameter is the first hover value v1 (i.e., 5 mm), wherein 0<h1<h2<h3, and v3>v2>v 1. Therefore, the user can judge the distances in Z-axis direction between the finger 4 and the surface of the capacitive touch panel 11 according to the sizes of the positioning feedback icons.

Based on the above, to be more precise, when the finger 4 is farther away from the surface of the capacitive touch panel 11, the greater is the deviation of the coordinates of the finger 4 sensed by the capacitive hover sensing module 1, accordingly a corresponding positioning feedback icon will be larger. Therefore, when the user's finger is above the surface of the capacitive touch panel 11 and moves from far to near towards the surface of the capacitive touch panel 11, the sizes of the corresponding positioning feedback icons will decrease in steps from large to small. When the user observes the positioning feedback icons changes from large to small as the finger 4 moves closer to the surface of the capacitive touch panel 11, the user will know that the coordinates of the finger 4 sensed by the capacitive hover sensing module 1 are more precise as the finger 4 moves closer towards the capacitive touch panel 11. And that enables the user to more accurately and conveniently know the positions of the finger 4 sensed by the capacitive floating sensing module 1 when his finger is hovering over the surface of the capacitive touch panel 11. Hence, the size changes of the positioning feedback icons according to the variations of the distances between the finger 4 and the surface of the capacitive touch panel 11 can provide a brand new and helpful user experience.

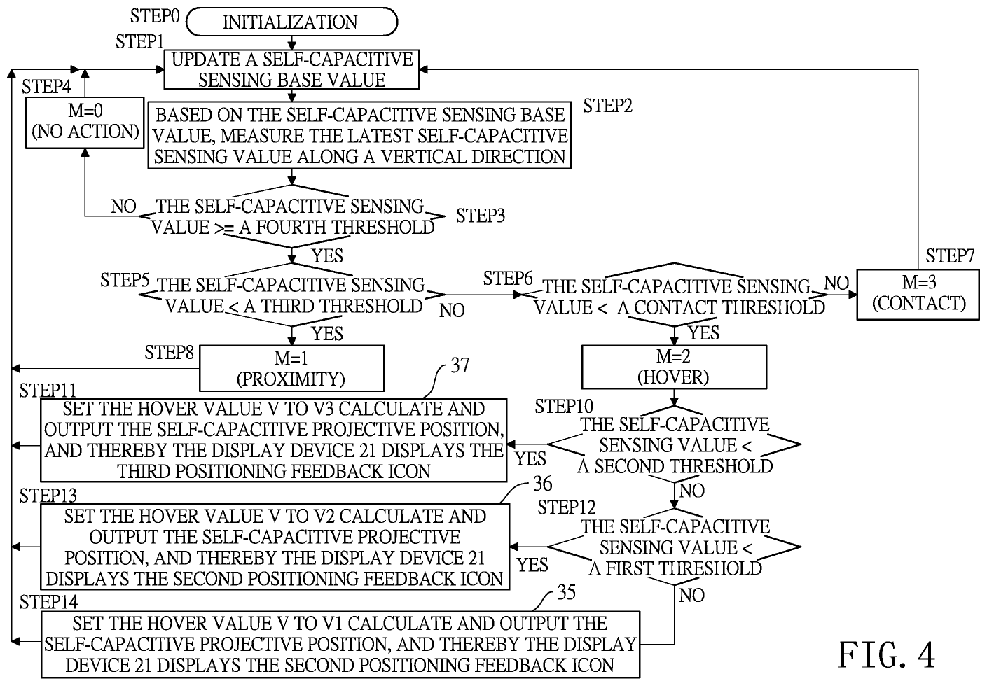

Please refer to FIG. 4. FIG. 4 shows the capacitive hover sensing method of the present invention, which is mainly used to determine a sensing mode M and a hover value v of a conductor object currently above the surface of the capacitive touch panel 11.

The capacitive hover sensing method of the present invention includes the following steps:

step 0: The capacitive hover sensing module 1 is initialized;

step 1: The capacitive hover sensing module 1 updates a self-capacitive sensing base value;

step 2: Based on the self-capacitive sensing base value, the capacitive hover sensing module 1 measures the latest self-capacitive sensing value along a vertical direction of the surface of the capacitive touch panel 11 (referring to Z-axis direction as shown in FIG. 2);

step 3: When the self-capacitive sensing value is greater than or equal to a fourth threshold (for example, 100), the flow jumps to step 5;

step 4: Set the sensing mode M of the conductor object to 0, and the flow jumps to step 1; note that, in this step, the self-capacitive sensing value is less than the fourth threshold, indicating that the conductor object is above the surface of the capacitive touch panel 11 and higher than the fourth height h4, which is out of the self-capacitance sensing range of the capacitive hover sensing module 1;

step 5: When the self-capacitive sensing value is less than a third threshold (for example, 900), the flow jumps to step 8;

step 6: When the self-capacitive sensing value is less than a contact threshold (for example, 26000), the flow jumps to step 9;

step 7: Set the sensing mode M of the conductor object to 3, and the flow jumps to step 1; note that, in this step, the conductor object directly contacts the surface of the capacitive touch panel 11, and the conductor object is sensed by using multi-point mutual capacitance sensing scheme, and mutual capacitive multiple point coordinates of the conductor object can be determined and output.

Step 8: Set the sensing mode M of the conductor object to 1, and the flow jumps to step 1; note that, in this step, the self-capacitive sensing value is between the third threshold and the fourth threshold, that is, the conductor object is above the surface of the capacitive touch panel 11 and between the horizontal planes corresponding to the third height h3 and the fourth height h4 (referring to FIG. 2, the conductor object is in the fourth sensing space 34), at this moment the capacitive hover sensing module 1 has detected the conductor object via the self-capacitance sensing, hence the conductor object is considered to be in proximity to the surface of the capacitive touch panel 11. However, the self-capacitance sensing of the capacitive hover sensing module 1 is still not precise enough about the projective position, only the existence of the conductor object is confirmed, and therefore the capacitive hover sensing module 1 sets the 2D coordinates of the conductor object to be at the center of the screen, such as (32768, 32768) to merely indicate the conductor object is in proximity to the capacitive touch panel 11.

Step 9: Set the sensing mode M of the conductor object to 2; note that, in this step, the self-capacitive sensing value is between the third threshold and the contact threshold, that is, the conductor object is above the capacitive touch panel 11 and between the horizontal plane corresponding to the third height h3 and the surface of the capacitive touch panel 11 (referring to FIG. 2, the conductor object is in the third sensing space 33, the second sensing space 32 or the first sensing space 31), at this moment the conductor object is regarded as hovering over the surface of the capacitive touch panel 11, and the self-capacitance sensing of the capacitive hover sensing module 1 can achieve a certain degree of accuracy for the projective position of the conductor object.

Step 10: When the self-capacitive sensing value is greater than or equal to a second threshold (for example, 8000), the flow jumps to step 12;

Step 11: Set the hover value v of the conductor object to the third hover value v3, the capacitive hover sensing module 1 calculates a self-capacitive projective position according to the self-capacitive sensing value and outputs the self-capacitive projective position to the graphical user interface 22, and thereby the display device 21 displays the third positioning feedback icon 37 whose diameter is the third hover value v3 (such as 15 mm), and the flow jumps to step 1;

Step 12: When the self-capacitive sensing value is greater than or equal to a first threshold (for example, 16000), the flow jumps to step 14;

Step 13: Set the hover value v of the conductor object to the second hover value v2, the capacitive hover sensing module 1 calculates a self-capacitive projective position according to the self-capacitive sensing value and outputs the self-capacitive projective position to the graphical user interface 22, and thereby the display device 21 displays the second positioning feedback icon 36 with a diameter of the second hover value v2 (such as 10 mm), and the flow jumps to step 1;

Step 14: Set the hover value v of the conductor object to the first hover value v1, the capacitive hover sensing module 1 calculates a self-capacitive projective position according to the self-capacitive sensing value and outputs the self-capacitive projective position to the graphical user interface 22, and thereby the display device 21 displays the first positioning feedback icon 35 with a diameter of the first hover value v1 (such as 5 mm), and the flow jumps to step 1.

From the above steps and embodiments of the capacitive hover sensing module of the present invention, it can be known that the positioning feedback icons not only allow the user to confirm the projective position of his finger on a capacitive touch panel (such as a coordinate point or an area), but also reminds the user about the height of the finger currently above the capacitive touch panel by changing the sizes of the positioning feedback icons, hence the present invention has fully utilized the signal sensed when the finger is hovering over or in proximity to the capacitive touch panel, and that fulfills the purposes of the present invention of enhancing the functionalities of the capacitive hover sensing module and providing a brand new and helpful user experience.

The aforementioned are preferred embodiments of the present invention. It should be noted that for those of ordinary skill in the art, without departing from the principles of the present invention, certain improvements and retouches of the present invention can still be made, which are nevertheless considered as within the protection scope of the present invention.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

1. A capacitive hover sensing module, including:
a capacitive touch panel for sensing a self-capacitive projective position of a conductor object on the capacitive touch panel, the conductor object located in a space facing the capacitive touch panel;
a touch driver chip, electrically connected with the capacitive touch panel and driving the capacitive touch panel, for measuring a sensing signal induced by the conductor object, and generating and outputting a sensing data accordingly;
a processor, electrically connected with the touch driver chip, for receiving the sensing data output by the touch driver chip;
according to the sensing data, in addition to generating the self-capacitive projective position of the conductor object on the capacitive touch panel when the conductor object is hovering over the capacitive touch panel, the processor also generating a hover value related to a vertical distance between the conductor object and the capacitive touch panel when the conductor object is hovering over the capacitive touch panel; wherein
the capacitive hover sensing module transmits the self-capacitive projective position and the hover value to a system end having a display device to display the self-capacitive projective position of the conductor object on the capacitive touch panel through a positioning feedback icon on the display device; wherein
a size of the positioning feedback icon is determined by the hover value of the conductor object; wherein
the capacitive hover sensing module measures a self-capacitive sensing value in the vertical direction of a surface of the capacitive touch panel, when the self-capacitive sensing value is between a fourth threshold and a third threshold, or when a distance between the conductive object and the capacitive touch panel is between a fourth height and a third height, the projective position of the conductor object is set at the center of the display device.

2. The capacitive hover sensing module as claimed in claim 1, wherein
when the self-capacitive sensing value is between the third threshold and a second threshold, the display device displays a third positioning feedback icon, and the size of the third positioning feedback icon is determined by a third hover value;
when the self-capacitive sensing value is between the second threshold and a first threshold, the display device displays a second positioning feedback icon, and the size of the second positioning feedback icon is determined by a second hover value;
when the self-capacitive sensing value is between the first threshold and a contact threshold, the display device displays a first positioning feedback icon, and the size of the first positioning feedback icon is determined by a first hover value; wherein the third threshold is less than the second threshold, the second threshold is less than the first threshold, and the first threshold is less than the contact threshold; and
the third hover value is greater than the second hover value, and the second hover value is greater than the first hover value.

3. (canceled)

4. The capacitive hover sensing module as claimed in claim 1, wherein when the self-capacitive sensing value is smaller than the fourth threshold, the conductor object is beyond a sensing range of the capacitive hover sensing module.

5. The capacitive hover sensing module as claimed in claim 1, wherein the first positioning feedback icon, the second positioning feedback icon and the third positioning feedback icon are circular.

6. The capacitive hover sensing module as claimed in claim 1, wherein
when the distance between the conductive object and the capacitive touch panel is between the third height and a second height, the display device displays a third positioning feedback icon, and the size of the third positioning feedback icon is determined by a third hover value;
when the distance between the conductive object and the capacitive touch panel is between the second height and a first height, the display device displays a second positioning feedback icon, and the size of the second positioning feedback icon is determined by a second hover value;
when the distance between the conductive object and the capacitive touch panel is less than the first height, the display device displays a first positioning feedback icon, and the size of the first positioning feedback icon is determined by a first hover value; wherein
the third height is greater than the second height, and the second height is greater than the first height;
the third hover value is greater than the second hover value, and the second hover value is greater than the first hover value.

7. (canceled)

8. The capacitive hover sensing module as claimed in claim 1, wherein
when the distance between the conductive object and the capacitive touch panel is greater than the fourth height, the conductive object is beyond the sensing range of the capacitive hover sensing module.

9. A capacitive hover sensing method, including:
measuring a self-capacitive sensing value induced by a conductive object hovering over a capacitive touch panel;
defining N threshold regions, connected by respective endpoints, and between a minimum threshold value and a maximum threshold value, wherein N is an integer greater than or equal to 2;
when the self-capacitive sensing value is between the minimum threshold value and the maximum threshold value, the self-capacitive sensing value is determined to be within a k^{th} threshold region among the N threshold regions, a hover value of the conductive object is set to a k^{th} hover value, where k is an integer greater than or equal to and less than or equal to N; wherein
according to the self-capacitive sensing value, a self-capacitive projection position is calculated and output, and thereby a display device displays the self-capacitive projection position through a k^{th} positioning feedback icon; wherein
the capacitive hover sensing module measures a self-capacitive sensing value in the vertical direction of a surface of the capacitive touch panel, when the self-capacitive sensing value is between an N^{th} threshold and an N^{th} threshold, or when a distance between the conductive object and the capacitive touch panel is between an N^{th} height and an N−1^{th} height, the projective position of the conductor object is set at the center of the display device.

10. The capacitive hover sensing method as claimed in claim 9, wherein
the size of the k^{th} positioning feedback icon is determined by the k^{th} hover value of the conductive object.
